(19) United States
(12) Patent Application Publication
(10) Pub. No.: US 2011/0282498 A1
(43) Pub. Date: Nov. 17, 2011

(54) SOLAR THERMAL DATA ACQUISITION SYSTEMS AND METHODS AND SYSTEMS USING THE SAME

(75) Inventors: Dale Freudenberger, Asheville, NC (US); John Hardy LeGwin, III, Asheville, NC (US); John Gravitt, Asheville, NC (US); Jessica Ingram, Asheville, NC (US)

(73) Assignee: FLS Solar Technologies, Inc.

(21) Appl. No.: 13/103,645

(22) Filed: May 9, 2011

Related U.S. Application Data
(60) Provisional application No. 61/333,544, filed on May 11, 2010.

(51) Int. Cl. G05D 23/19; G05D 7/06; G06F 15/00; F24J 2/00

(52) U.S. Cl. 700/282; 126/569; 702/130

(57) ABSTRACT

A method for monitoring a solar thermal energy system including a solar thermal loop and a heat consumption loop thermally coupled by a heat exchanger, the solar thermal loop including a solar collector device fluidly connected to the heat exchanger and a primary heat transfer fluid disposed in the solar thermal loop and flowing through the solar collector device and the heat exchanger, the heat consumption loop including a heat consuming apparatus fluidly connected to the heat exchanger and a secondary heat transfer fluid disposed in the heat consumption loop and flowing through the heat consuming apparatus and the heat exchanger, includes: detecting an inlet temperature of the secondary heat transfer fluid upstream of the heat consuming apparatus or the heat exchanger, and generating corresponding inlet temperature data; detecting an outlet temperature of the secondary heat transfer fluid downstream of the heat consuming apparatus or the heat exchanger, and generating corresponding outlet temperature data; detecting a flow rate of the secondary heat transfer fluid through the heat consuming apparatus or the heat exchanger and generating corresponding flow rate data; determining an amount of thermal energy transferred from the secondary heat transfer fluid to the heat consuming apparatus or the heat exchanger using the inlet temperature data, the outlet temperature data, and the flow rate data, and generating corresponding consumption data; detecting a performance parameter of the solar thermal loop and generating corresponding solar thermal performance data; and correlating the consumption data and the solar thermal performance data for subsequent analysis.

### RELATED APPLICATION(S)

This application claims the benefit of and priority from U.S. Provisional Patent Application No. 61/333,544, filed May 11, 2010, the disclosure of which is incorporated herein by reference in its entirety.

### FIELD OF THE INVENTION

The present invention relates to solar energy recovery systems and methods and, more particularly, to solar thermal energy recovery systems and methods incorporating data acquisition for monitoring and/or managing operation of the system.

### BACKGROUND OF THE INVENTION

Solar thermal energy systems are used to harness or recover and store solar radiation energy as thermal energy (heat), and provide the recovered thermal energy for a desired useful purpose. Typically, the solar thermal energy system includes a solar collector, a first heat transfer medium flowing through the solar collector in a first loop, and a heat exchanger to transfer heat from the first heat transfer medium to a second heat transfer medium flowing through a second loop. The second heat transfer fluid may in turn be used to transfer heat to a further device or medium, or may be directly consumed (e.g., as potable hot water).

In addition to the direct benefit of the thermal energy provided by the solar thermal energy system, the system may also provide certain credits in a program directed to encouraging the use of renewable or reduced emissions (e.g., CO₂) energy production technology. Such credits may be purchased and used to satisfy mandates in a compliance market such as those modeled under the Renewable Portfolio Standard in various states of the United States. These credits may be embodied in Renewable Energy Certificates (RECs), which are tradable, non-tangible energy securities or commodities in the United States that represent proof that a quantity (e.g., 1 MWh) of electricity or its equivalent was generated from an eligible renewable energy resource. The thermal energy recovered by the thermal energy system can be metered, converted to kilowatt-hours (kWh), and certified. Other types of credits derived from solar thermal energy production that may be awarded for solar thermal energy production include energy conservation or efficiency credits (e.g., white tags) and greenhouse gas offsets.

### SUMMARY OF THE INVENTION

According to embodiments of the present invention, a method is provided for monitoring a solar thermal energy system including a solar thermal loop and a heat consumption loop thermally coupled by a heat exchanger, the solar thermal loop including a solar collector device fluidly connected to the heat exchanger and a primary heat transfer fluid disposed in the solar thermal loop and flowing through the solar collector device and the heat exchanger, the heat consumption loop including a heat consuming apparatus fluidly connected to the heat exchanger and a secondary heat transfer fluid disposed in the heat consumption loop and flowing through the heat consuming apparatus and the heat exchanger. The method includes: detecting an inlet temperature of the secondary heat transfer fluid upstream of the heat consuming apparatus or the heat exchanger, and generating corresponding inlet temperature data; detecting an outlet temperature of the secondary heat transfer fluid downstream of the heat consuming apparatus or the heat exchanger, and generating corresponding outlet temperature data; detecting a flow rate of the secondary heat transfer fluid through the heat consuming apparatus or the heat exchanger, and generating corresponding flow rate data; determining an amount of thermal energy transferred from the secondary heat transfer fluid to the heat consuming apparatus or the heat exchanger using the inlet temperature data, the outlet temperature data, and the flow rate data, and generating corresponding consumption data; detecting a performance parameter of the solar thermal loop and generating corresponding solar thermal performance data; and correlating the consumption data and the solar thermal performance data for subsequent analysis.

According to some embodiments, the method includes correlating the solar thermal performance data and the consumption data as a function of time.

According to embodiments of the present invention, a solar thermal energy system includes a heat exchanger, a solar thermal loop, a heat consumption loop, and a solar thermal data acquisition system. The solar thermal loop includes: a solar collector device fluidly connected to the heat exchanger; and a primary heat transfer fluid disposed in the solar thermal loop and flowing through the solar collector device and the heat exchanger. The heat consumption loop is thermally coupled to the solar thermal loop by the heat exchanger and includes: a heat consuming apparatus fluidly connected to the heat exchanger; and a secondary heat transfer fluid disposed in the heat consumption loop and flowing through the heat consuming apparatus and the heat exchanger. The solar thermal data acquisition system includes: an inlet temperature sensor operative to detect an inlet temperature of the secondary heat transfer fluid upstream of the heat consuming apparatus or the heat exchanger, and to generate inlet temperature signals embodying corresponding inlet temperature data; an outlet temperature sensor operative to detect an outlet temperature of the secondary heat transfer fluid downstream of the heat consuming apparatus or the heat exchanger, and to generate outlet temperature signals embodying corresponding outlet temperature data; a flow sensor to detect a flow rate of the secondary heat transfer fluid through the heat consuming apparatus or the heat exchanger, and to generate flow rate signals embodying corresponding flow rate data; at least one solar thermal performance sensor to detect a performance parameter of the solar thermal loop and generate solar thermal performance signals embodying corresponding solar thermal performance data; and a controller. The controller is operative to: receive the inlet temperature signals, the outlet temperature signals, and the flow rate signals; determine an amount of thermal energy transferred from the secondary heat transfer fluid to the heat consuming apparatus or the heat exchanger using the inlet temperature data, the outlet temperature data, and the flow rate data, and generate corresponding consumption data; and correlate the consumption data and the solar thermal performance data for subsequent analysis.

According to embodiments of the present invention, a method is provided for managing a solar thermal energy system including first and second solar collector devices each having a respective inlet and a respective outlet, a conduit network interconnecting the first and second collector devices, and a heat transfer fluid disposed in the first and second solar collector devices and the conduit network to flow therethrough, wherein the solar collector devices collect incident solar energy to heat the heat transfer fluid as the heat transfer fluid flows through the first and second solar collector devices. The method includes: detecting the temperature of the heat transfer fluid at the inlet and outlet of each of the first and second solar collector devices using a plurality of temperature sensors and generating corresponding temperature data; detecting flow rates of the heat transfer fluid through each of the first and second solar collector devices using at least one flow sensor and generating corresponding flow rate data; determining a first thermal energy change in the thermal energy of the heat transfer fluid across the first solar collector device using the temperature data and the flow rate data; and determining a second thermal energy change in the thermal energy of the heat transfer fluid across the second solar collector device using the temperature data and the flow rate data.

In some embodiments, the method includes adjusting a flow rate of the heat transfer fluid through the first solar collector device based on the first and second thermal energy changes. In some embodiments, the conduit network is arranged and configured for parallel flow of the heat transfer fluid through the first and second solar collector devices, and the method includes adjusting a flow rate of the heat transfer fluid through the first solar collector device relative to a flow rate of the heat transfer fluid through the second solar collector device based on the first and second thermal energy changes. The method may include: detecting a first flow rate of the heat transfer fluid through the first solar collector device using a first flow sensor and generating corresponding first flow rate data; detecting a second flow rate of the heat transfer fluid through the second solar collector device using a second flow sensor and generating corresponding second flow rate data; determining the first thermal energy change using the first flow rate data; and determining the second thermal energy change using the second flow rate data.

According to some embodiments, the method includes: generating temperature signals from the temperature sensors embodying the temperature data; generating flow rate signals from the at least one flow rate sensor embodying the flow rate data; receiving the temperature and flow rate signals at a controller; and using the controller to: programmatically determine the first thermal energy change using the temperature data and the flow rate data; and programmatically determine the second thermal energy change using the temperature data and the flow rate data.

According to embodiments of the present invention, a solar thermal energy system includes: first and second solar collector devices each having a respective inlet and a respective outlet; a conduit network interconnecting the first and second collector devices; a heat transfer fluid disposed in the first and second solar collector devices and the conduit network to flow therethrough; and a solar thermal data acquisition system. The first and second solar collector devices collect incident solar energy to heat the heat transfer fluid as the heat transfer fluid flows through the first and second solar collector devices. The solar thermal data acquisition system includes: a plurality of temperature sensors operative to detect the temperature of the heat transfer fluid at the inlet and outlet of each of the first and second solar collector devices and generate temperature signals embodying corresponding temperature data; at least one flow sensor to detect flow rates of the heat transfer fluid through each of the first and second solar collector devices and generate flow rate signals embodying corresponding flow rate data; and a controller. The controller is configured to: receive the temperature and flow rate signals; determine a first thermal energy change in the thermal energy of the heat transfer fluid across the first solar collector device using the temperature data and the flow rate data; and determine a second thermal energy change in the thermal energy of the heat transfer fluid across the second solar collector device using the temperature data and the flow rate data.

According to embodiments of the present invention, a method is provided for monitoring a solar energy system including a solar collector device mounted at an installation location. The method includes: mounting a solar thermal performance sensor at the installation location adjacent the solar collector device to detect a performance parameter of the solar collector device and generate corresponding solar performance data; generating wireless solar performance signals embodying the solar performance data using a wireless transmitter operatively connected to the solar performance sensor and located adjacent the solar collector device; wirelessly receiving the solar performance signals at a handheld mobile terminal; and reporting the solar performance data and/or data derived therefrom to an operator of the handheld mobile terminal using the handheld mobile terminal.

In some embodiments, the installation location is on a building structure and elevated above ground level.

In some embodiments, the solar thermal performance sensor is an insolation sensor.

According to method embodiments of the present invention, a method for monitoring a solar thermal energy system including a solar thermal loop, the solar thermal loop including a solar collector device and a primary heat transfer fluid disposed in the solar thermal loop and flowing through the solar collector device, the primary heat transfer fluid including antifreeze, includes: using an electronic antifreeze sensor, detecting a concentration of the antifreeze in the primary heat transfer fluid; generating an antifreeze level signal corresponding to the concentration of the antifreeze in the primary heat transfer fluid; and receiving the antifreeze level signal at a remote terminal.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a schematic elevational view of a solar thermal energy system according to embodiments of the present invention installed on a building structure, the solar thermal energy system including a solar thermal data acquisition system according to embodiments of the present invention.

FIG. 2 is a schematic diagram representing the solar thermal energy system of FIG. 1.

FIG. 3 is a schematic diagram representing a controller forming a part of the solar thermal data acquisition system of FIG. 1.

FIG. 4 is a diagram representing a solar thermal data acquisition system network according to embodiments of the present invention.

FIGS. 5-7 are flowcharts representing methods according to embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

The flowcharts and block diagrams of certain of the figures herein illustrate exemplary architecture, functionality, and operation of possible implementations of embodiments of the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently.

The term “programmatically” refers to operations directed and/or carried out electronically by computer modules, code and instructions.

The term “electronically” includes both wireless and wired connections between components.

According to embodiments of the present invention, methods and systems are provided for monitoring, assessing and/or managing a solar thermal energy system using a data acquisition system. In some embodiments, the methods and systems may be particularly well-suited for use where solar collector panels are mounted at an elevated location (e.g., on a raised roof) that is difficult, time consuming or dangerous to access. In some embodiments, the methods and systems may facilitate improved operation or configuration of the solar thermal energy system to enable improved operation efficiency.

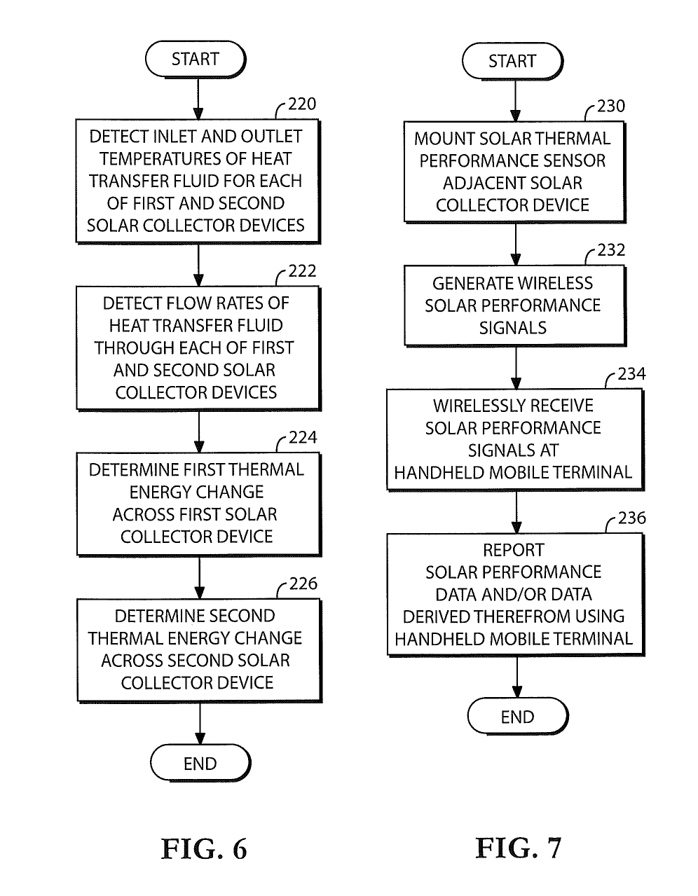

With reference to FIG. 5, a method according to embodiments of the present invention for monitoring a solar thermal energy system including a solar thermal loop and a heat consumption loop thermally coupled by a heat exchanger, the solar thermal loop including a solar collector device fluidly connected to the heat exchanger and a primary heat transfer fluid disposed in the solar thermal loop and flowing through the solar collector device and the heat exchanger, the heat consumption loop including a heat consuming apparatus fluidly connected to the heat exchanger and a secondary heat transfer fluid disposed in the heat consumption loop and flowing through the heat consuming apparatus and the heat exchanger, is represented therein. In the method, an inlet temperature of the secondary heat transfer fluid upstream of the heat consuming apparatus or the heat exchanger is detected and corresponding inlet temperature data is generated (Block 202). An outlet temperature of the secondary heat transfer fluid downstream of the heat consuming apparatus or the heat exchanger is detected and corresponding outlet temperature data is generated (Block 204). A flow rate of the secondary heat transfer fluid through the heat consuming apparatus or the heat exchanger is detected and corresponding flow rate data is generated (Block 206). An amount of thermal energy transferred from the secondary heat transfer fluid to the heat consuming apparatus or the heat exchanger is determined using the inlet temperature data, the outlet temperature data, and the flow rate data, and generating corresponding consumption data (Block 208). A performance parameter of the solar thermal loop is detected and corresponding solar thermal performance data is generated (Block 210). The consumption data and the solar thermal performance data are correlated for subsequent analysis (Block 212).

With reference to FIG. 6, a method according to embodiments of the present invention for managing a solar thermal energy system including first and second solar collector devices each having a respective inlet and a respective outlet, a conduit network interconnecting the first and second collector devices, and a heat transfer fluid disposed in the first and second solar collector devices and the conduit network to flow therethrough, wherein the solar collector devices collect incident solar energy to heat the heat transfer fluid as the heat transfer fluid flows through the first and second solar collector devices, is illustrated therein. In the method, the temperature of the heat transfer fluid at the inlet and outlet of each of the first and second solar collector devices is detected using a plurality of temperature sensors and corresponding temperature data is generated (Block 220). Flow rates of the heat transfer fluid through each of the first and second solar collector devices are detected using at least one flow rate sensor and corresponding flow rate data is generated (Block 222). A first thermal energy change in the thermal energy of the heat transfer fluid across the first solar collector device is determined using the temperature data and the flow rate data (Block 224). A second thermal energy change in the thermal energy of the heat transfer fluid across the second solar collector device is determined using the temperature data and the flow rate data (Block 226).

With reference to FIG. 7, a method according to embodiments of the present invention for monitoring a solar energy system including a solar collector device mounted at an installation location is illustrated therein. The method includes mounting a solar thermal performance sensor at the installation location adjacent the solar collector device to detect a performance parameter of the solar collector device and generate corresponding solar performance data (Block 230). Wireless solar performance signals embodying the solar performance data are generated using a wireless transmitter operatively connected to the solar performance sensor and located adjacent the solar collector device (Block 232). The solar performance signals are wirelessly received at a handheld mobile terminal (Block 234). The solar performance data and/or data derived therefrom is reported to an operator of the handheld mobile terminal using the handheld mobile terminal (Block 236).

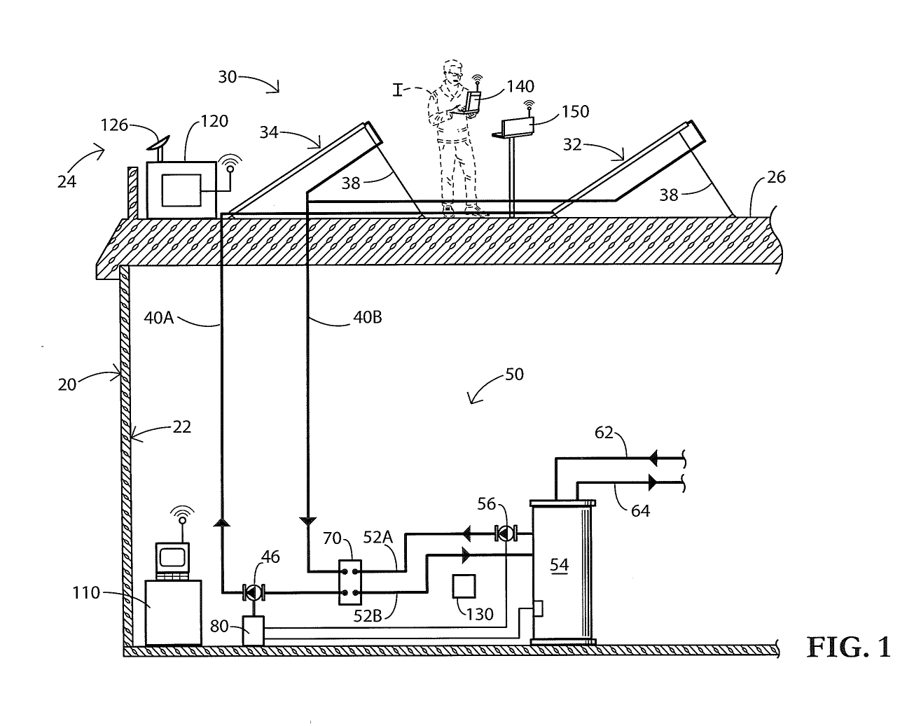

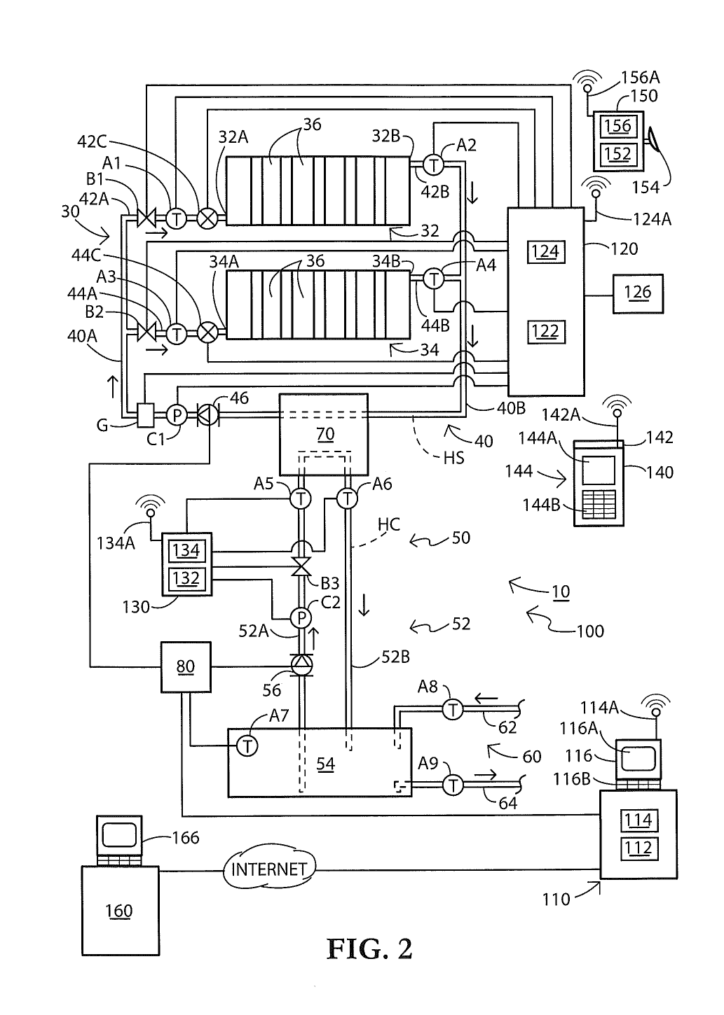

Systems and methods for monitoring and/or managing a solar thermal energy system will now be described with reference to FIGS. 1-4. Referring to FIGS. 1 and 2, a solar thermal energy system 10 according to embodiments of the present invention is shown therein. The system 10 includes a solar thermal subsystem, circuit or loop 30, a heat consumption subsystem, circuit or loop 50, a heat exchanger 70, and a differential controller 80. These subsystems and components may be of known or conventional construction, arrangement and operation, for example. The system 10 further includes a solar thermal data acquisition system 100. As discussed herein, the solar thermal data acquisition system 100 can enable a method for remotely monitoring the performance of the solar thermal energy system 10 and reporting both performance data at the level of solar collector devices in the solar thermal loop 30 and thermal energy production (e.g., BTU production) for the overall system 10. The data acquisition system 100 can report or display this data locally and remotely (e.g., on a mobile terminal). Remote reporting may be accomplished via a wireless network or the Internet.

The system 10 is installed on and in a building structure 20. However, it will be appreciated that, according to some embodiments, the system 10 may be installed in building structures of other designs or not in/on a building structure. The illustrative building structure 20 includes a lower level 22, an elevated (e.g., uppermost or exposed) level 24, and a roof 26.

As illustrated, the solar thermal loop 30 includes a pair of solar collector devices such as solar thermal arrays 32, 34 disposed on the roof 26. However, according to other embodiments, more or fewer solar thermal arrays may be employed. Each array 32, 34 includes a plurality of solar thermal collector panels 36 (FIG. 2) fluidly interconnected in series. The arrays 32, 34 may be mounted on support frames 38 (FIG. 1). The array 32 has a fluid inlet 32A and a fluid outlet 32B (FIG. 2). The array 34 has a fluid inlet 34A and a fluid outlet 34B.

With reference to FIG. 2, the solar thermal loop 30 further includes a primary conduit network 40. The primary conduit network 40 includes a feed connector section 40A, array feed sections 42A, 44A, a return connector section 40B, and array return sections 42B, 44B. Valves 42C and 44C are provided to selectively control flow through the array feed sections 42A, 44B, respectively. The conduit network 40, the arrays 32, 34 and the heat exchanger 70 form a closed fluid loop. The conduit network 40 is arranged and configured such that the arrays 32, 34 are connected to the feed and return conduit sections 40A, 40B (and thereby the heat exchanger 70) are parallel (i.e., to provide parallel flow of the heat transfer fluid HS through the arrays 32, 34). A circulating pump 46 (e.g., an impeller pump) is provided in the solar thermal loop 30 to drive a flow of the heat transfer fluid HS through the conduit network 40, the arrays 32, 34 and the heat exchanger 70 in the direction as illustrated by the arrows in FIG. 2.

The heat consumption loop 50 includes a conduit network 52, a storage tank 54, a pump 56 and an end use loop 60. The conduit network 52 includes a feed or take-up section 52A and a return section 52B. The end use loop 60 includes a feed conduit 62 and a removal conduit 64 to feed secondary heat transfer fluid to and withdraw secondary heat transfer fluid HC from the storage tank 54. The conduit network 52, the heat exchanger 70 and the storage tank 54 collectively form an endless fluid loop. The pump 56 is operable to drive the secondary heat transfer fluid HC through the conduit network 52 and the heat exchanger 70 in the direction indicated by the arrows in FIG. 2.

The heat transfer fluids HS, HC may be any suitable heat transfer fluids. According to some embodiments, the heat transfer fluids HS, HC are both water. According to some embodiments, the heat transfer fluids are different materials. In some embodiments, the secondary heat transfer fluid HC is potable water. According to some embodiments, the primary heat transfer fluid HS is glycol, water, or a mixture thereof or oil.

The data acquisition system 100 includes a local central server 110, a solar loop data collector module 120, a consumption loop data collector module 130, a mobile receiver unit or monitor terminal 140, a solar performance sensor module 150, a remote server 160, pressure sensors C1, C2, temperature sensors A1-A9, and flow rate sensors B1-B3. The particular configuration and arrangement of the components of the data acquisition system 100 may vary from the systems as illustrated. For example, there may be provided more or fewer handheld terminals, there may be additional data collector modules, the functionality of the local central server 110 may be distributed across a plurality of servers, or additional pressure, temperature or flow sensors may be provided.

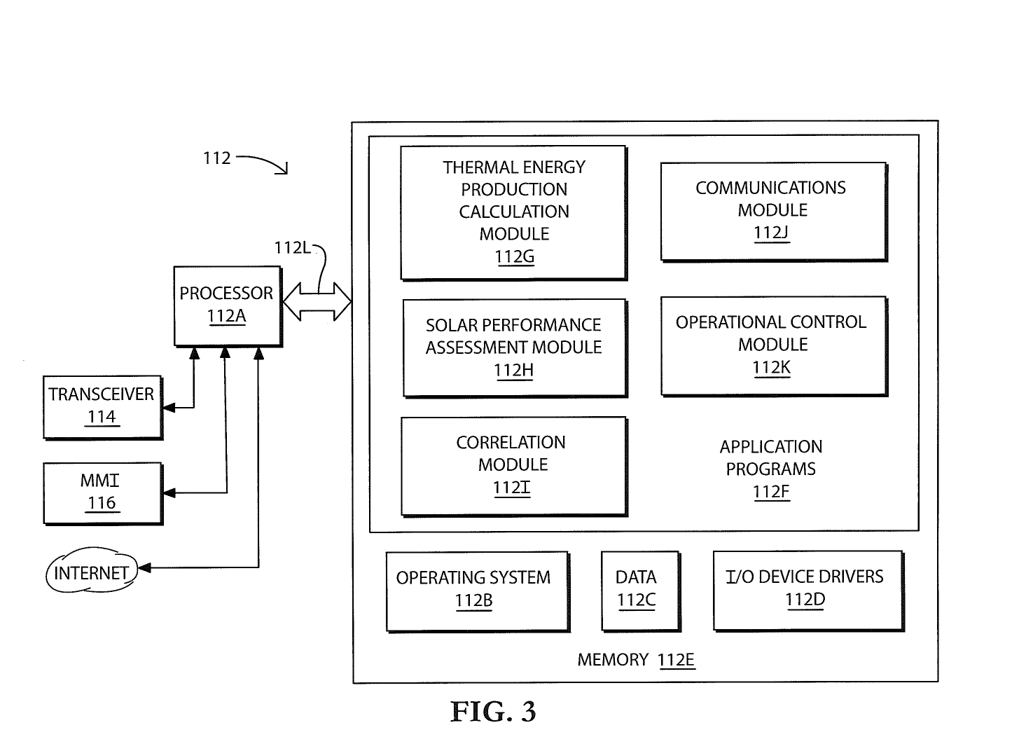

Referring to FIG. 2, the local central server 110 includes a controller 112, a wireless transceiver 114, an antenna 114A, and a man-machine interface (MMI) 116. FIG. 3 is a schematic illustration of a circuit or data processing system that can be used in the controller 112. The circuits and/or data processing systems may be incorporated in a digital signal processor 112A in any suitable device or devices. As shown in FIG. 3, the processor 112A communicates with the transceiver 114, the MMI 116, and memory 112E via an address/data bus 112L. The processor 112A can be any commercially available or custom microprocessor. The memory 112E is representative of the overall hierarchy of memory devices containing the software and data used to implement the functionality of the data processing system. The memory 112E can include, but is not limited to, the following types of devices: cache, ROM, PROM, EPROM, EEPROM, flash memory, SRAM, and DRAM.

FIG. 3 illustrates that the memory 112E may include several categories of software and data used in the data processing system: the operating system 112B; the application programs 112F; the input/output (I/O) device drivers 112D; and data 112C. The data 112C can include equipment-specific data. FIG. 3 also illustrates the application programs 112F can include a thermal energy production calculation module 112G, a solar performance assessment module 11211, a correlation module 112I, a communications module 112J, and an operational control module 112K.

As will be appreciated by those of skill in the art, the operating system 112B may be any operating system suitable for use with a data processing system, such as OS/2, AIX, DOS, OS/390 or System390 from International Business Machines Corporation, Armonk, NY, Windows CE, Windows NT, Windows95, Windows98, Windows2000 or other Windows versions from Microsoft Corporation, Redmond, Wash., Unix or Linux or FreeBSD, Palm OS from Palm, Inc., Mac OS from Apple Computer, LabView, or proprietary operating systems. The I/O device drivers 112D typically include software routines accessed through the operating system 112B by the application programs 112F to communicate with devices such as I/O data port(s), data storage and certain memory components. The application programs 112F are illustrative of the programs that implement the various features of the data processing system and can include at least one application, which supports operations according to embodiments of the present invention. Finally, the data 112C represents the static and dynamic data used by the application programs 112F, the operating system 112B, the I/O device drivers 112D, and other software programs that may reside in the memory 112E.

As will be appreciated by those of skill in the art, other configurations may also be utilized while still benefiting from the teachings of the present invention. For example, one or more of the modules 112G-K may be incorporated into the operating system, the I/O device drivers or other such logical division of the data processing system. Thus, the present invention should not be construed as limited to the configuration of FIG. 3, which is intended to encompass any configuration capable of carrying out the operations described herein. Further, one or more of the modules can communicate with or be incorporated totally or partially in other components, such as the remote server 160, a data collector module 120, 130, or a handheld terminal 140.

The MMI 116 may include any suitable input device(s) 116B and output devices 116A. The input devices may include, for example, a keyboard, mouse, touch screen, and/or touchpad. The output devices 116A may include, for example, a visual display device and/or an audio transducer.

The solar loop data collector module 120 includes a controller 122, a wireless transceiver 124 and an antenna 124A. The data collector module 120 may further include a battery, which may be recharged by a photovoltaic cell 126, to serve as a power supply. The controller 122 may be generally configured and operate as discussed above with regard to the controller 112 except that the application programs and data stored are configured or adapted to execute the functions or operations described herein for the data collector module 120.

The consumption loop data collector module 130 includes a controller 132, a wireless transceiver 134, and an antenna 134A. The data collector module 130 may be configured and operate as described for the solar loop data collector module 120, except that the application programs and data stored are configured or adapted to execute the functions or operations described herein for the data collector module 130.

The mobile terminal 140 includes a controller, a transceiver 142, an antenna 142A and an MMI 144. The MMI 144 may include any suitable input device 144B (e.g., a keypad, touch screen, touch sensitive device, or trackball) and/or any suitable output device, such as a visual display (e.g., an LCD screen) and/or an audio transducer.

The mobile terminal 140 may be a dedicated device or a general purpose device (e.g., a smart phone) with suitable firmware and/or software (e.g., a software application or “app”).

According to some embodiments, the mobile terminal 140 is a handheld mobile terminal. By “handheld mobile terminal,” it is meant that the outer dimensions of the mobile terminal are adapted and suitable for use by a typical operator using one hand. According to some embodiments, the total volume of the handheld mobile terminal 140 is less than about 80 cubic inches. According to some embodiments, the total volume of the handheld mobile terminal 140 is less than about 33 cubic inches.

The solar performance sensor module 150 includes a controller 152, a sensor device 154, a wireless transceiver 156 and an antenna 156A. The sensor device 154 may be any suitable type of sensor device. According to some embodiments, the sensor device 154 is an insolation sensor. Other types of sensor devices that may be employed include ambient air temperature, wind speed, and wind direction sensors.

The pressure sensor C1 is located in the conduit network 40 and the pressure sensor C2 is located in the conduit network 52. The pressure sensors C1, C2 may be of any suitable construction to detect a pressure of the associated heat transfer fluid HS, HC and generate a corresponding electrical signal. According to some embodiments, the pressure sensors C1, C2 are differential, strain gauge, or capacitive sensors. The pressure sensor C1 is disposed in the conduit network 40 to detect the pressure of the heat transfer fluid HS flowing therethrough. The pressure sensor C2 is disposed in the conduit network 50 to detect the pressure of the heat transfer fluid HC flowing therethrough.

The flow rate sensor B1 is located on the solar loop 30 (e.g., on the feed section 42A) to detect the mass flow rate of the heat transfer fluid HS through the array 32. The flow rate sensor B2 is located on the solar loop 30 (e.g., on the feed section 44A) to detect the mass flow rate of the heat transfer fluid HS through the array 34. The flow rate sensor B3 is located on the consumption loop 50 (e.g., on the feed section 52A) to detect the mass flow rate of the heat transfer fluid HC through the heat exchanger 70. The flow rate sensors B1-B3 may be of any suitable construction to detect the mass flow rate of the heat transfer fluid HS, HC and generate a corresponding electrical signal. According to some embodiments, the flow rate sensors B1-B3 are turbity, turbine, or paddle sensors. One or more of the flow rate sensors B1-B3 may be replaced or supplemented by detection of the mass flow rate using the pump 46, 56 in the corresponding conduit network 40, 52. According to some embodiments, the flow rate sensors B1-B3 are integrated into the conduit 40, 50.

The temperature sensors A1-A4 are mounted on the solar loop 30 to detect the temperature of the heat transfer fluid HS at different locations in the loop. More particularly, the temperature sensor Al is mounted at or proximate the array inlet 32A (e.g., in the array feed section 42A as illustrated), the temperature sensor A2 is mounted at or proximate the array outlet 32B (e.g., in the array return section 42B), the temperature sensor A3 is mounted at or proximate the array inlet 34A (e.g., in the array feed section 44A), and the temperature sensor A4 is mounted at or proximate the array outlet 34B (e.g., in the array return section 44B).

The temperature sensors A5, A6 are mounted on the heat consumption loop 50 to detect the temperature of the heat transfer fluid HC at different locations in the loop. More particularly, the temperature sensor A5 is located on the feed side of the heat exchanger 70 (e.g., in the feed section 52A proximate the heat exchanger inlet) and the temperature sensor A6 is located on the return side of the heat exchanger 70 (e.g., in the return section 52B proximate the heat exchanger outlet).

Additional temperature sensors A7, A8 and A9 may be provided to detect the temperature of the heat transfer fluid HC in the storage tank 54, in the end use feed or return conduit 62, and in the end use removal conduit 64, respectively.

The various temperature sensors A1-A9 may be of any suitable construction or type to detect the temperature of the heat transfer fluid HS, HC and generate a corresponding electrical signal. According to some embodiments, the temperature sensors A1-A9 are resistance sensors.

The remote server 160 may be constructed and operative generally as described above with regard to the local central server 110 and includes an MMI 166. The remote server 160 may be disposed at a location physically remote from the structure 20 and connected to the local server 110 for communications, for example, via the Internet.

The solar loop data collector module 120 is operatively connected to the sensors A1-A4, B1, B2, C1 to receive sensor data therefrom. The data collector module 120 may be located relatively proximate the sensors A1-A4, B1, B2, C1 (e.g., on the roof 26) so that wired connections (as illustrated in FIG. 2) can be conveniently deployed. The data collector module 120 may also provide signals to the sensors A1-A4, B1, B2, C1 such as wake up or polling instructions. The data collector module 120 may also be operably connected to the valves 42C, 44C to detect the settings or positions of the valves 42C, 44C and/or to adjust the settings of the valves 42C, 44C (e.g., in the case of motor actuated automatic valves 42C, 44C). The data collector module 120 and the local control server 110 are configured to communicate data over a wireless interface enabled by the transceivers 114, 124 and the antennas 114A, 124A. The communicated data includes solar loop performance data generated or relayed by the data collector module 120, and may also include instructions or other data from the local remote server 110 to the data collector module 120.

The heat consumption loop data collector module 130 is operatively connectors to the sensors A5, A6, B3, C2 to receive sensor data therefrom. The data collector module 130 may be located relatively proximate the sensors A5, A6, B3, C2 (e.g., in a lower level of the building 20) so that wired connections (as illustrated in FIG. 2) can be conveniently made. The data collector module 130 may also provide signals to the sensors A5, A6, B3, C2 such as wake up or polling instructions. The data collector module 130 and the local central server 110 are configured to communicate over a wireless interface enabled by the transceivers 114, 134 and the antennas 114A, 134A. The communicated data includes heat consumption loop data generated or relayed by the data collector module 130, and may also include instructions or other data from the local remote sensor 110 to the data collector module 130.

The solar performance sensor module 150 and the local central server 110 are configured to communicate data over a wireless interface enabled by the transceivers 114, 156 and the antennas 114A, 156A. The communicated data includes solar performance data generated by the module 150 based on the environmental condition(s) detected by the sensor 154 (e.g., the level of solar insolation). The communicated data may also include instructions from the server 110 to the module 150.

The mobile terminal 140 and the local central server 110 are configured to communicate data over a wireless interface enabled by the transceivers 114, 142 and the antennas 114A, 142A.

The differential controller 80 may be wired to the sensor A7, a temperature sensor in the solar loop 30 (e.g., the temperature sensor, A2 or the temperature sensor A4), and the pump 56 in known manner. The differential controller 80 may also be wired to the local control server 110 in order to communicate sensor data or pump speed data, for example, to the server 110, or to enable communication of instructions or other data from the server 110 to the differential controller 80.

The wireless interfaces between the local control server 110 and the modules 120, 130, 140, 150 can include any suitable type of wireless interface. According to some embodiments, the wireless interfaces are radiofrequency (RF) wireless interfaces. The RF wireless interfaces can include a wireless local area network (WLAN) interface, a direct point-to-point wireless interface and/or a cellular communication wireless interface. Each transceiver 114, 124, 134, 142, 156 typically has a transmitter circuit and a receiver circuit, which respectively transmit outgoing radio frequency signals (e.g., to a network, a router or directly to another terminal) and receive incoming radio frequency signals (e.g., from a network, a router or directly to another terminal), via the associated antenna. The transceiver may include a short range transmitter and receiver, such as a Bluetooth transmitter and receiver. The antenna may be an embedded antenna, a retractable antenna or any antenna known to those having skill in the art without departing from the scope of the present invention.

In the case of a WLAN interface, the handheld terminal 140, modules 120, 130, 150 or server 110 can communicate through a WLAN router using a communication protocol that may include, but is not limited to, 802.11a, 802.11b, 802.11e, 802.11g, 802.11i, and/or 802.11n.

A direct point-to-point connection transceiver may include a direct RF communication transceiver or a direct IR communication transceiver. The direct RF communication transceiver may include a Bluetooth transceiver. With a Bluetooth transceiver, the handheld terminal 140, data collector module 120, 130, 150 or server 110 can communicate via an ad-hoc network through a direct point-to-point interface.

With a cellular communication interface, the handheld terminal 140, module 120, 130, 150 or server 110 can communicate via a base station(s) of a network using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

Exemplary installation and operation of the system 10 will now be described in more detail. With reference to FIG. 1, the heat consumption loop 50 may be mounted on the lower level 22 of the structure 20, such as in a storage or utility room. The solar thermal arrays 32, 34 are installed on the roof 26. The solar loop data collector module 120 and the solar performance sensor module 150 are also mounted on the roof 26 proximate the arrays 32, 34. The local central server 110 and the consumption loop data collector module 130 may be mounted on the lower level 22 proximate the consumption loop 50.

Once installed, the solar thermal energy system 10 may be operated in known manner, for example, to recover solar radiation energy as heat and transfer the heat to the heat transfer fluid HC for consumption. The heat transfer fluid HS is circulated through the arrays 32, 34 and the heat exchanger 70 by the pump 46 while the heat transfer fluid HC is circulated through the storage tank 54 and the heat exchanger 70 by the pump 56. Heat from the relatively hot heat transfer fluid HS is transferred to the relatively cool heat transfer fluid HC in the heat exchanger 70. The heated heat transfer fluid HC is returned to the storage tank 54 via the conduit 52B, where it increases the temperature of the heat transfer fluid HC in the storage tank 54.

The heated heat transfer fluid HC can be drawn off via the conduit 64 for any suitable use, such as hot water for personal consumption or heating of the building structure. The removed heat transfer fluid HC may be replaced or returned to the storage tank 54 via the conduit 62. It will be appreciated that other arrangements may be employed. For example, the conduits 62, 64 or the conduits 52A, 52B may be a closed loop in the storage tank so that the consumed fluid is not the same as the heat transfer fluid HC circulated through the storage tank 54.

The pumps 46, 56 may be operated and coordinated by the differential controller 80. The differential controller 80 senses the difference in temperature between the temperature of the fluid HC in the consumption loop 50 (e.g., in the storage tank 54 or at the temperature sensor A6) and the temperature of the fluid HS in the solar thermal loop 30. The temperature in the storage tank 54 may be detected using the temperature sensor A7. The temperature of the heat transfer fluid HS may be detected using the temperature sensor A2 or the temperature sensor A4, or a further temperature sensor in the solar thermal loop 30. The temperature sensor(s) of the solar thermal loop 30 used for this purpose may be wired to the differential controller 80 or may communicate wirelessly with a receiver (e.g., the server 110 via the data collector module 120). Typically, the differential controller 80 turns the pump 56 on when the temperature of the fluid HS exceeds the temperature of the fluid HC by at least a prescribed temperature differential. In this way, the differential controller 80 can ensure that the fluid HS gains heat from the fluid HC when the pump 56 operates and not vice-versa. The differential controller 80 may also control the flow rate of the pump 46 to achieve a desired temperature in the fluid HC dependent on the rate of heat absorption by the arrays 32, 34.

The data acquisition system 100 may be used to monitor and assess the operation of the system 10. According to some embodiments, the consumption loop data collector module 130 detects the temperature T₅ of the heat transfer fluid HC fed to the heat exchanger 70, the temperature T₆ of the heat transfer fluid HC exiting the heat exchanger 70, the pressure P₂ of the heat transfer fluid HC, and the flow rate F₃ of the heat transfer fluid HC through the conduit sections 52A, 52B using the sensors A5, A6, B3, and C2, respectively. The data collector module 130 wirelessly transmits this data (heat transfer fluid inlet temperature data, outlet temperature data, pressure data and flow rate data) to the local central server 110. The pressure P₂ can be monitored to detect whether the pump 56 has stopped operating.

The local central server 110 uses the inlet temperature T₅, outlet temperature T₆, and flow rate F₃ data and the thermal energy production calculation module 112G to programmatically determine the thermal energy (heat) gain ΔQ₃ in the heat transfer fluid HC from the heat exchanger 70 (i.e., from the solar thermal loop 30). The thermal energy gain ΔQ₃ may be calculated using the following formula:

ΔQ₃=m₃c*(T₆−T₅)
where: m₃ is the mass of the heat transfer fluid HC; and
c is the specific heat of the heat transfer fluid HC.
m₃ can be calculated as m₃=F₃ (volumetric)*(density of the heat transfer fluid HC).

The calculated thermal energy gain (consumption data) ΔQ₃ may be stored in memory and time indexed.

According to some embodiments, the solar thermal loop data collector module 120 detects the inlet temperatures T₁, outlet temperature T₂ and the flow rate F₁ of the heat transfer fluid HS through the array 32 using the sensors A3, A4 and B2, respectively. The data collector module 120 detects the inlet temperature T₃, outlet temperature T₄ and flow rate F₂ through the array 34 using the sensors A3, A4 and B2, respectively. The data collector module 120 may also detect the pressure of the heat transfer fluid HS using the pressure sensor C1. The data collector module 120 wirelessly transmits this solar performance data (the inlet temperature data for each array 32, 34, the outlet temperature data for each array 32, 34, the flow rate data for each array 32, 34, and the pressure data) to the local central server 110.

The local central server 110 (or, for example, the remote server 160, as discussed below) uses the foregoing solar performance data and the solar performance assessment module 112H to programmatically calculate the thermal energy (heat) gain ΔQ₁ in the heat transfer fluid HS from the array 32 and the thermal energy gain ΔQ₂ in the heat transfer fluid HS from the array 34. The thermal heat gains ΔQ₁, ΔQ₂ may be calculated using the following formulas:

ΔQ₁=m₁c*(T₂−T₁);ΔQ₂=m₂c*(T₄−T₃)
where: m₁, m₂ are the masses of the heat transfer fluid HS (determined from the density of the heat transfer fluid HS and F₁ and F₂, respectively); and
c is the specific heat of the heat transfer fluid HC.

The calculated array thermal heat gains ΔQ₁, ΔQ₂ may be stored in memory and time indexed.

The solar performance sensor module 150 detects a condition or parameter relating to solar performance using the sensor 154. According to some embodiments, the parameter is solar insolation. The corresponding solar performance sensor data can be wirelessly transmitted to the local central server 110. The solar performance sensor data may be stored in the memory of the server 110 and time indexed.

The local central server 110 (or, for example, the remote server 160), using the correlation module 1121, can correlate by-time the calculated thermal energy gain ΔQ₃, the calculated array thermal heat gains ΔQ₁, ΔQ₂, and the solar performance sensor data from the sensor 154 (e.g., solar isolation data). The correlated data can then be logged, reported and analyzed. For example, by monitoring and correlating the thermal energy production data on the consumption loop side with the solar insolation level and/or the heat gains across each of the arrays 32, 34, an operator can determine performance and efficiency profiles or trends for the system 10, compare the effects of the different system settings on heat production in the consumption loop 50, and/or compare the effects of different environmental conditions on heat production in the consumption loop 50. The server 110 (or remote server 160) may log the data to retain a repository of historical data, and may also process the data to identify and report trends in performance.

The consumption data, solar performance data and other data associated with or derived therefrom can be reported to an operator via the MMI 116. In particular, the local central server 110 can process the data and generate a graphical user interface (GUI) that is displayed on the display 116A.

The local central server 110 may wirelessly transmit the thermal energy production data and/or the solar performance data to the mobile terminal 140 where the data may likewise be processed and displayed in a GUI, for example. The mobile terminal 140 may be particularly useful during installation, maintenance or tuning of the system 10 in that a technician I (FIG. 1) can be disposed at various locations relative to the system 10 in order to make adjustments or modifications to or observe different components of the system and nonetheless be able to access the thermal energy production data and the solar performance data for reference and feedback. For example, the technician I may be disposed on the roof 26 in order to access and adjust the valves 42C, 44C. By way of further example, the technician may be located on a lower floor away from the solar performance sensor module 150, but still be able to monitor the solar performance parameter (e.g., solar insolation) in real-time.

As discussed above, the server 110 (or the remote server 160) can calculate and report a respective heat gain value for each of the arrays 32 and 34 using the associated set of temperature and flow sensors A1, A2, B1 and A3, A4, B2. Using this data, the technician can compare the heat gains ΔQ₃, ΔQ₁, ΔQ₂ and determine whether a significant imbalance exists, that is, the heat transfer fluid HS assumes a significantly greater heat gain through one array 32, 34 than through the other array 32, 34. With this information, the technician can suitably adjust one or more of the valves 42C, 44C or make other modifications (e.g., repair or replace an array 32, 34) to bring the heat gains of the arrays 32, 34 into equal or closer to equal balance. For example, the valve 42C, 44C of the array 32, 34 with less heat gain may be closed (i.e., further restricted) to reduce the flow rate therethrough.

As noted, the server 110 (or the remote server 160) can correlate solar insolation data with the thermal energy production ΔQ₃ in the consumption loop 50 as well as to the heat gain ΔQ₁, ΔQ₂ in each array 32, 34. In this way, the server 110 can serve to monitor and display the consumption loop thermal energy production and/or the array or solar loop heat gains as a function of the solar insolation on the arrays 32, 34.

According to some embodiments, the solar thermal energy production on the consumption loop is calculated and reported in British Thermal Units (btus). The solar thermal energy production expressed in btus may be used for the purpose of assessing and billing a customer for the thermal energy consumed from the consumption loop 50.

The server 110 (or the server 160) may further calculate or convert the consumption loop thermal energy production to kWh for use in supporting a Renewable Energy Certificate or Credit (REC). The kWh value may be displayed on the MMI 116, for example, and stored for later retrieval. The thermal energy production kWh value (E) may be calculated as:

E=ΔQ₃/3412

According to some embodiments, the data collector modules 120, 130 can wirelessly transmit the above-described thermal energy production data and solar performance data directly to the mobile terminal 140 or via a non-processing relay device (e.g., a conventional wireless router). According to some embodiments, the mobile terminal 140 includes a controller configured to execute the functionality described herein with regard to the local central server 110.

The local central server 110 may transmit the various data described above, including correlated data, to the remote server 160. The remote server 160 may be located offsite a substantial distance from the solar thermal loop 30 and the consumption loop 50. The data may be encrypted and transmitted over the Internet to the remote server 160. The transmitted data and/or data derived therefrom may be displayed on or otherwise reported by the remote server 160 (e.g., via the MMI 166 using an Internet browser).

While various components, functions and operations have been described as forming a part of or being performed by the local central server 110, according to some embodiments, these components, functions and operations may be distributed among or relocated to others of the modules or servers 120, 130, 140, 160, for example. For example, the local central server 110 may serve as a relay device that does minimal or substantially less processing of the data from the modules 120, 130 but wirelessly receives and forwards such data to the remote server 160. In this case, the remote server 160 may include the modules 112G-K and serve to process the data (e.g., calculate the thermal energy production data, calculate the array heat gains, and correlate the thermal energy production data, the solar thermal performance data and/or the solar insolation data). The remote server 160 may then transmit the calculated and correlated data to the local central server 110, which displays the received data on the MMI 116 and/or wirelessly transmits the received data to the mobile terminal 140.

By way of further example, one or more of the data collector modules 120, 130 may be configured to process data as described with regard to the server 110. For example, the solar loop data collector module 120 may calculate the array heat gains ΔQ₁, ΔQ₂ and transmit the same to the server 110, the consumption loop data collector module 130 may calculate the thermal energy production ΔQ₃ and transmit the same to the server 110, and the server 110 may serve to time correlate the received array heat gain data ΔQ₁, ΔQ₂ and thermal energy production data ΔQ₃.

By way of further example, various functionality of the server 110 can be incorporated in one or more of the modules 120, 130, 150. In some embodiments, the one or more of the modules 120, 130, 150 is directly connected to the Internet (e.g., via a wired, satellite, or cellular link) so that some or all of the data provided thereby can be accessed without use of the local central server 110 and/or without use of a direct link to the handheld terminal 140. In some embodiments, one or more of the modules 120, 130, 150 is provided with its own man-machine interface.

Communications between the various modules and servers 110, 120, 130, 140, 150, 160 can be accomplished through processing and/or non-processing relay devices. Such communications can be enabled by a wireless mesh or network with data being relayed over any number of nodes.

While the solar collector devices 32, 34 as described herein are multi-panel solar thermal arrays, other types of solar thermal collector devices may be used. More than two solar collector devices may be arranged for parallel flow in the conduit network 40, According to some embodiments, only a single solar thermal array is provided in the solar thermal loop 30. According to still further embodiments, two or more solar collector devices (e.g., solar thermal arrays) may be fluidly connected in series. In this case, temperature sensors may be provided between adjacent ones of the solar collector devices and the temperature data collected from the temperature sensors can be used to calculate the heat gain in the heat transfer fluid HS across each solar collector device.

The solar collector devices 32, 34 may comprise flat panel, concentrating parabolic trough, or other suitable types of collectors.

According to some embodiments, the data acquisition system 100 (e.g., using the server 110) may programmatically calculate thermal energy production using the server data from the temperature sensors A1, A2, the flow rate sensor B2, and the pressure sensor C1 (or the sensors A3, A4, B2, and C1).

According to some embodiments, the valves 42C, 44C are equipped with electronically controlled actuator mechanisms that enable remote or automatic adjustment of the valves 42C, 44C. The local server 110, for example, is operatively connected to the valves to control the actuators. According to some embodiments, the server 110 programmatically determines what adjustments are advantageous to improve the efficiency of the solar loop 30 based on comparison of the array heat gains ΔQ₁, ΔQ₂ or outlet temperatures T₂, T₄, and automatically adjusts the valves 42C, 44C and the flow rates therethrough in accordance with this determination.

Accordingly to some embodiments, the server 110 communicates wirelessly with a module more proximate the valves 42C, 44C (e.g., the data collector module 120) and which is wired to the valves 42C, 44C in order to actuate the valves 42C, 44C.

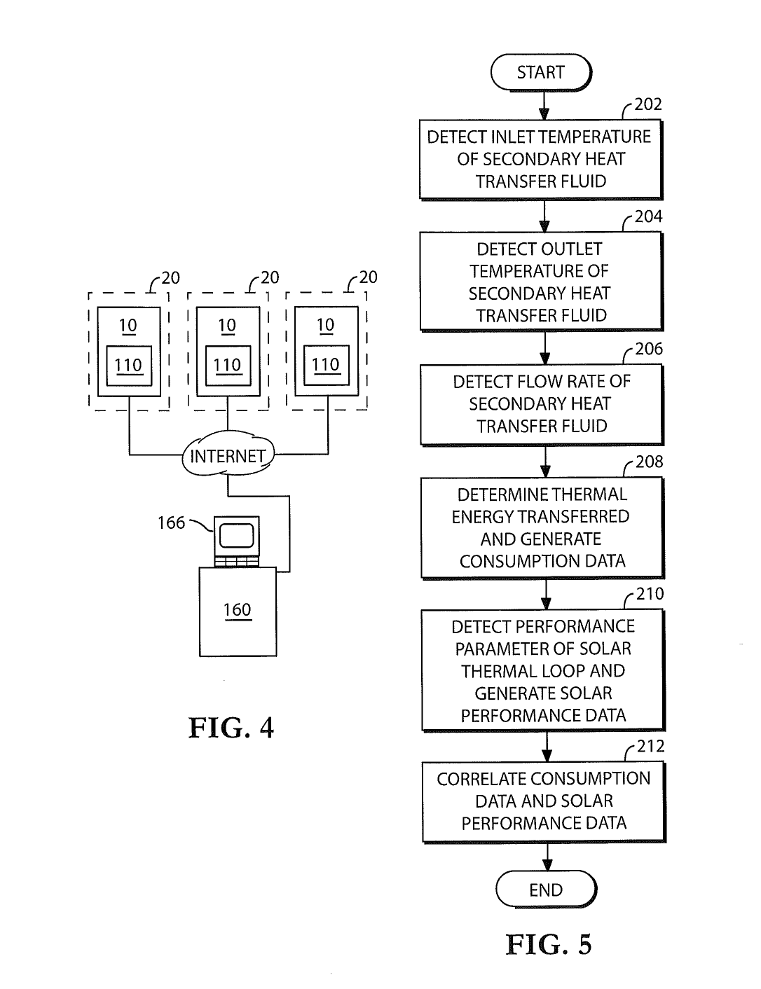

With reference to FIG. 4, the remote server 160 may serve as a central server that communicates (e.g., via the Internet) with a plurality of local central servers 110 at respective, spatially distributed locations. For example, the local central servers 110 each may be associated with solar thermal energy systems 10 located in different buildings 20 or other spaced apart sites. The remote server 160 may be under the control of and located in a facility of a vendor or utility that charges the consumer for the thermal energy produced by the respective system 10 and/or accumulates data to certify or apply for certification of RECs generated from the thermal energy produced by the system 10.

With reference to FIG. 2, the system 10 may include an electronic antifreeze concentration sensor G and the heat transfer fluid HS can include a mixture of antifreeze and another liquid such as water. According to some embodiments, the antifreeze is glycol (e.g., ethylene glycol or propylene glycol). The concentration of the antifreeze in the heat transfer fluid HS should be maintained at at least a prescribed level to prevent freezing of the heat transfer fluid HS under certain cold conditions. However, over time, the antifreeze may degrade or become diluted so that the concentration of the antifreeze in the heat transfer fluid HS drops below the prescribed level.

In accordance with some embodiments of the invention, the antifreeze concentration sensor G detects the concentration of the heat transfer fluid HS and electronically reports the same to the data collector module 120 (or another suitable module). The module 120 generates an antifreeze level signal embodying data representing the antifreeze concentration level and transmits the antifreeze level signal to a remote terminal such as the local central server 110, the mobile terminal 140, or the remote server 160. The module 120 may report the actual antifreeze concentration (e.g., as a concentration of antifreeze by volume or weight) and/or may report that the antifreeze concentration is below the prescribed concentration. According to some embodiments, the module 120 (or another terminal in the system 10) generates or pushes an alert or notification to a remote terminal to warn an operator that the antifreeze concentration is below the prescribed level. The system 10 can thereby programmatically determine and analyze the concentration of antifreeze in the heat transfer fluid HS, and electronically and (if desired) automatically report the concentration or a derived status to an operator at a remote terminal.

The antifreeze concentration sensor G may be of any type or construction, such as a DWF-S in-line density sensor. Suitable antifreeze concentration sensors may include the 2500-10000 I/H DWF-S sensor available from Heinrichs of Germany.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A method for monitoring a solar thermal energy system including a solar thermal loop and a heat consumption loop thermally coupled by a heat exchanger, the solar thermal loop including a solar collector device fluidly connected to the heat exchanger and a primary heat transfer fluid disposed in the solar thermal loop and flowing through the solar collector device and the heat exchanger, the heat consumption loop including a heat consuming apparatus fluidly connected to the heat exchanger and a secondary heat transfer fluid disposed in the heat consumption loop and flowing through the heat consuming apparatus and the heat exchanger, the method comprising:
detecting an inlet temperature of the secondary heat transfer fluid upstream of the heat consuming apparatus or the heat exchanger, and generating corresponding inlet temperature data;
detecting an outlet temperature of the secondary heat transfer fluid downstream of the heat consuming apparatus or the heat exchanger, and generating corresponding outlet temperature data;
detecting a flow rate of the secondary heat transfer fluid through the heat consuming apparatus or the heat exchanger and generating corresponding flow rate data;
determining an amount of thermal energy transferred from the secondary heat transfer fluid to the heat consuming apparatus or the heat exchanger using the inlet temperature data, the outlet temperature data, and the flow rate data, and generating corresponding consumption data;
detecting a performance parameter of the solar thermal loop and generating corresponding solar thermal performance data; and
correlating the consumption data and the solar thermal performance data for subsequent analysis.

2. The method of claim 1 including correlating the solar thermal performance data and the consumption data as a function of time.

3. A solar thermal energy system comprising:
a) a heat exchanger;
b) a solar thermal loop including:
a solar collector device fluidly connected to the heat exchanger; and
a primary heat transfer fluid disposed in the solar thermal loop and flowing through the solar collector device and the heat exchanger;
c) a heat consumption loop thermally coupled to the solar thermal loop by the heat exchanger and including:
a heat consuming apparatus fluidly connected to the heat exchanger; and
a secondary heat transfer fluid disposed in the heat consumption loop and flowing through the heat consuming apparatus and the heat exchanger;
d) a solar thermal data acquisition system including:
an inlet temperature sensor operative to detect an inlet temperature of the secondary heat transfer fluid upstream of the heat consuming apparatus or the heat exchanger, and to generate inlet temperature signals embodying corresponding inlet temperature data;
an outlet temperature sensor operative to detect an outlet temperature of the secondary heat transfer fluid downstream of the heat consuming apparatus or the heat exchanger, and to generate outlet temperature signals embodying corresponding outlet temperature data;
a flow sensor to detect a flow rate of the secondary heat transfer fluid through the heat consuming apparatus or the heat exchanger, and to generate flow rate signals embodying corresponding flow rate data;
at least one solar thermal performance sensor to detect a performance parameter of the solar thermal loop and generate solar thermal performance signals embodying corresponding solar thermal performance data; and
a controller operative to:
receive the inlet temperature signals, the outlet temperature signals, and the flow rate signals;
receive the solar thermal performance data;
determine an amount of thermal energy transferred from the secondary heat transfer fluid to the heat consuming apparatus or the heat exchanger using the inlet temperature data, the outlet temperature data, and the flow rate data, and generate corresponding consumption data; and
correlate the consumption data and the solar thermal performance data for subsequent analysis.

4. A method for managing a solar thermal energy system including first and second solar collector devices each having a respective inlet and a respective outlet, a conduit network interconnecting the first and second collector devices, and a heat transfer fluid disposed in the first and second solar collector devices and the conduit network to flow therethrough, wherein the solar collector devices collect incident solar energy to heat the heat transfer fluid as the heat transfer fluid flows through the first and second solar collector devices, the method comprising:
detecting the temperature of the heat transfer fluid at the inlet and outlet of each of the first and second solar collector devices using a plurality of temperature sensors and generating corresponding temperature data;
detecting flow rates of the heat transfer fluid through each of the first and second solar collector devices using at least one flow sensor and generating corresponding flow rate data;
determining a first thermal energy change in the thermal energy of the heat transfer fluid across the first solar collector device using the temperature data and the flow rate data; and
determining a second thermal energy change in the thermal energy of the heat transfer fluid across the second solar collector device using the temperature data and the flow rate data.

5. The method of claim 4 including adjusting a flow rate of the heat transfer fluid through the first solar collector device based on the first and second thermal energy changes.

6. The method of claim 5 wherein the conduit network is arranged and configured for parallel flow of the heat transfer fluid through the first and second solar collector devices, and including adjusting a flow rate of the heat transfer fluid through the first solar collector device relative to a flow rate of the heat transfer fluid through the second solar collector device based on the first and second thermal energy changes.

7. The method of claim 6 including:
detecting a first flow rate of the heat transfer fluid through the first solar collector device using a first flow sensor and generating corresponding first flow rate data;
detecting a second flow rate of the heat transfer fluid through the second solar collector device using a second flow sensor and generating corresponding second flow rate data;
determining the first thermal energy change using the first flow rate data; and
determining the second thermal energy change using the second flow rate data.

8. The method of claim 4 including:
generating temperature signals from the temperature sensors embodying the temperature data;
generating flow rate signals from the at least one flow rate sensor embodying the flow rate data;
receiving the temperature and flow rate signals at a controller; and
using the controller to:
programmatically determine the first thermal energy change using the temperature data and the flow rate data; and
programmatically determine the second thermal energy change using the temperature data and the flow rate data.

9. A solar thermal energy system comprising:
a) first and second solar collector devices each having a respective inlet and a respective outlet;
b) a conduit network interconnecting the first and second collector devices;
c) a heat transfer fluid disposed in the first and second solar collector devices and the conduit network to flow therethrough, wherein the first and second solar collector devices collect incident solar energy to heat the heat transfer fluid as the heat transfer fluid flows through the first and second solar collector devices; and
d) a solar thermal data acquisition system including:
a plurality of temperature sensors operative to detect the temperature of the heat transfer fluid at the inlet and outlet of each of the first and second solar collector devices and generate temperature signals embodying corresponding temperature data;
at least one flow sensor to detect flow rates of the heat transfer fluid through each of the first and second solar collector devices and generate flow rate signals embodying corresponding flow rate data;
a controller configured to:
receive the temperature and flow rate signals;
determine a first thermal energy change in the thermal energy of the heat transfer fluid across the first solar collector device using the temperature data and the flow rate data; and
determine a second thermal energy change in the thermal energy of the heat transfer fluid across the second solar collector device using the temperature data and the flow rate data.

10. A method for monitoring a solar energy system including a solar collector device mounted at an installation location, the method comprising:
mounting a solar thermal performance sensor at the installation location adjacent the solar collector device to detect a performance parameter of the solar collector device and generate corresponding solar performance data;
generating wireless solar performance signals embodying the solar performance data using a wireless transmitter operatively connected to the solar performance sensor and located adjacent the solar collector device;
wirelessly receiving the solar performance signals at a handheld mobile terminal; and
reporting the solar performance data and/or data derived therefrom to an operator of the handheld mobile terminal using the handheld mobile terminal.

11. The method of claim 10 wherein the installation location is on a building structure and elevated above ground level.

12. The method of claim 10 wherein the solar thermal performance sensor is an insolation sensor.

13. A method for monitoring a solar thermal energy system including a solar thermal loop, the solar thermal loop including a solar collector device and a primary heat transfer fluid disposed in the solar thermal loop and flowing through the solar collector device, the primary heat transfer fluid including antifreeze, the method comprising:
using an electronic antifreeze sensor, detecting a concentration of the antifreeze in the primary heat transfer fluid;
generating an antifreeze level signal corresponding to the concentration of the antifreeze in the primary heat transfer fluid; and
receiving the antifreeze level signal at a remote terminal.
